(19) United States
(12) Patent Application Publication
(10) Pub. No.: US 2026/0331087 A1
(43) Pub. Date: Oct. 22, 2026

(54) KARAOKE DEVICE AND OPERATION METHOD USING ORIGINAL SOUND SOURCE

(71) Applicant: GAUDIO LAB, INC., Seoul (KR)

(72) Inventors: Sangbae CHON, Seoul (KR); Hyunoh OH, Gyeonggi-do (KR); Jeonghun SEO, Seoul (KR); Keum Bit HWANG, Seoul (KR); Sungmin KIM, Gyeonggi-do (KR); Hyeongi MOON, Seoul (KR); Pilsun EU, Seoul (KR); Gunwoo HAN, Gyeonggi-do (KR)

(21) Appl. No.: 19/647,840

(22) Filed: Apr. 14, 2026

(30) Foreign Application Priority Data
Apr. 21, 2025 (KR) 10-2025-0051410
Jul. 18, 2025 (KR) 10-2025-0097199

(51) Int. Cl. G10H 1/36

(52) U.S. Cl. CPC G10H 1/361

(57) ABSTRACT

A karaoke device using an original sound source including a singing voice is disclosed. The karaoke device includes a processor. The processor obtains, from an audio signal corresponding to the original sound source, a first audio signal corresponding to the singing voice and a second audio signal corresponding to audio excluding the singing voice and determines a gain value to mix the first audio signal with the second audio signal depending on whether a user of the karaoke device sings.

### BACKGROUND OF THE INVENTION

### Field of the invention

The disclosure relates to a karaoke device and an operation method using an original sound source.

### Description of the Prior Art

Karaoke culture was once a leisure and entertainment culture limited to specific regions, but recently, it is becoming a globally loved leisure and entertainment culture. Previously, karaoke devices were designed to generate audio by using a MIDI device or provide pre-generated low-quality instrumental performance sound sources and lyrics. Therefore, low-quality instrumental performance sound source could also become a factor that hinders a singer and a listener from being immersed in the song. In addition, due to the limitations of real-time audio signal processing, there were also limitations in the functions provided by the karaoke device.

With the development of real-time audio processing technology, it is now possible to expect improved performance of karaoke devices. In particular, it is now possible to expect to provide karaoke devices that use original sound sources containing singers' vocals.

### SUMMARY OF THE INVENTION

An embodiment of the disclosure is to provide a karaoke device and an operation method using an original sound source.

According to an embodiment of the disclosure, a karaoke device using an original sound source including a singing voice includes a processor. The processor obtains, from an audio signal corresponding to the original sound source, a first audio signal corresponding to the singing voice and a second audio signal corresponding to audio excluding the singing voice and determines a value of gain to mix the first audio signal with the second audio signal depending on whether a user of the karaoke device sings.

The processor may, when applying the value of gain, change the value of mixing gain previously obtained according to whether the user sings to the determined value of mixing gain.

The processor may determine the speed of the change, based on the tempo of the original sound source.

The processor may determine the speed of the change, based on the number of syllables uttered per predetermined unit time of the original sound source.

The processor may configure the speed of the change when the user starts singing to be different from the speed of the change when the user stops singing.

The processor may, when adjusting the pitch of the audio corresponding to the second audio signal, adjust the pitches of sounds except for a sound corresponding to percussion instruments.

The processor may receive sound source separation metadata indicating information required to separate the first audio signal from the audio signal corresponding to the original sound source and use the sound source separation metadata to obtain the second audio signal from the audio signal corresponding to the original sound source.

The sound source separation metadata may include frequency band-specific mask information used for the first audio signal separation.

The sound source separation metadata may include information indicating a time interval in which the first audio signal separation is required.

According to an embodiment of the disclosure, an operation method of a karaoke device using an original sound source including a singing voice may include obtaining, from an audio signal corresponding to the original sound source, a first audio signal corresponding to the singing voice and a second audio signal corresponding to audio excluding the singing voice and determining a value of gain to mix the first audio signal with the second audio signal according to whether a user of the karaoke device sings.

The operation method may further include changing the value of mixing gain previously obtained according to whether the user sings to the determined value of mixing gain.

The changing of the value of mixing gain previously obtained according to whether the user sings to the determined value of mixing gain may include determining the speed of the change, based on the tempo of the original sound source.

The changing of the value of mixing gain previously obtained according to whether the user sings to the determined value of mixing gain may include determining the speed of the change, based on the number of syllables uttered per predetermined unit time of the original sound source.

The changing of the value of mixing gain previously obtained according to whether the user sings to the determined value of mixing gain may include configuring the speed of the change when the user starts singing to be different from the speed of the change when the user stops singing.

The operation method may further include, when adjusting the pitch of the audio corresponding to the second audio signal, adjusting the pitches of sounds except for a sound corresponding to percussion instruments.

The operation method may further include receiving sound source separation metadata indicating information required to separate the first audio signal from the audio signal corresponding to the original sound source and using the sound source separation metadata to obtain the second audio signal from the audio signal corresponding to the original sound source.

The sound source separation metadata may include frequency band-specific mask information used for the first audio signal separation.

The sound source separation metadata may include information indicating a time interval in which the first audio signal separation is required.

The device and method according to an embodiment of the disclosure can provide a karaoke device and an operation method using an original sound source.

### BRIEF DESCRIPTION OF THE DRAWINGS

The above and other aspects, features and advantages of the disclosure will be more apparent from the following detailed description taken in conjunction with the accompanying drawings, in which:

FIG. 1 is a block diagram illustrating a karaoke device according to an embodiment of the disclosure;

FIG. 2 illustrates an operation of a karaoke device processing an input audio signal and input lyrics by using metadata according to an embodiment of the disclosure;

FIG. 3 illustrates an operation of a karaoke device processing an input audio signal and input voice according to an embodiment of the disclosure; and

FIG. 4 illustrates a karaoke device determining an output of a guide vocal based on whether the user is singing according to an embodiment of the disclosure.

### DETAILED DESCRIPTION OF THE EXEMPLARY EMBODIMENTS

Hereinafter, the embodiments of the disclosure will be described in detail with reference to the attached drawings, so that those of ordinary skill in the art to which the disclosure pertains may practice the embodiments of the disclosure with ease. However, the disclosure may be implemented in various different forms and is not limited to the embodiments described herein. In addition, in the drawings, parts that are not related to the description for clearly explaining the disclosure have been omitted, and the similar reference numerals are used to refer to the similar parts throughout the specification. In addition, when a portion is described as “including” a component, this does not exclude other components unless otherwise specified, but rather may include other components.

An audio signal processing device according to an embodiment of the disclosure includes at least one processor. The operation of the audio signal processing described in the disclosure may be an operation of an instruction set executed by a processor included in the audio signal processing device.

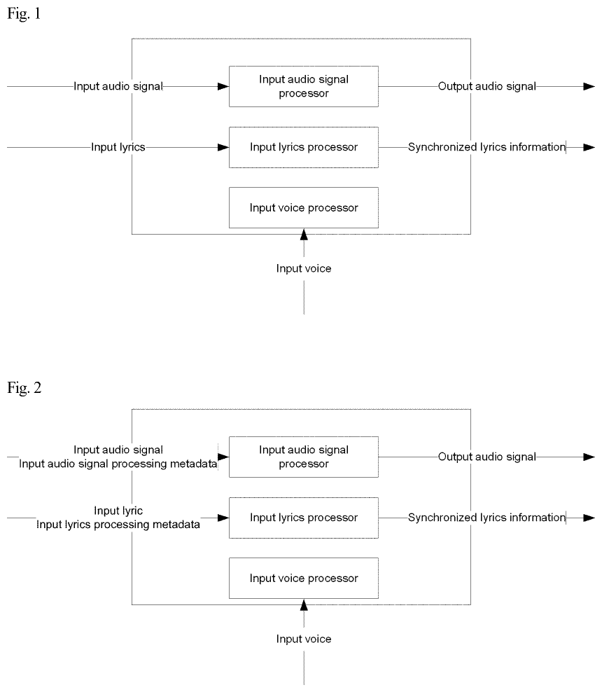

FIG. 1 is a block diagram illustrating a karaoke device according to an embodiment of the disclosure.

The karaoke device may receive at least one of an input audio signal, input lyrics, and input voice. In this case, the karaoke device may include at least one of an input audio signal processor for processing the input audio signal, an input lyrics processor for processing the input lyrics, and an input voice processor for processing the input voice.

The input audio signal processor may remove voice from the input audio signal, for example, the original sound source. This allows a singer to sing using the accompaniment, which includes the instrumental performance included in the original sound source, as is. In addition, the input audio signal processor may customize the original sound source. This allows the user to comfortably customize the accompaniment for comfortable singing. In this case, the input audio signal processor may selectively process only some of the instrumental performances included in the original sound source. Customization may include adjusting the volume, pitch, or beat. For example, the input audio signal processor may adjust the volume of audio corresponding to a specific instrument, adjust the pitch or beat of audio corresponding to a specific instrument, or remove audio corresponding to a specific instrument.

In addition, the input audio signal processor may optionally output the voice included in the input audio signal. Specifically, the input audio signal processor may output the voice included in the input audio signal depending on whether the input voice is received. This allows the input audio signal processor to enhance the effect of allowing a singer to naturally enjoy the song even if the singer temporarily stops singing. The operation of the input audio signal processor is described in detail through FIGS. 2 to 4.

The input lyrics processor may synchronize the input lyrics with the output audio signal to output them.

The input voice processor may perform filtering to remove remaining audio components other than the singer's voice, such as ambient noise or output audio, from the input voice. In addition, the input voice processor may perform pitch correction.

FIG. 2 illustrates an operation of a karaoke device processing an input audio signal and input lyrics by using metadata according to an embodiment of the disclosure.

The input audio signal processor of the karaoke device described above may perform sound source separation in real time to remove the voice from the input audio signal. In this case, the input audio signal processor may remove the main vocal voice from the input audio signal. The sound source separation may be performed using a bandpass filter. In addition, the sound source separation may be performed in real time through a machine learning model. When real-time separation is performed through a machine learning model, the speed of the sound source separation process may decrease depending on the processing performance of the karaoke device. In addition, the sound source separation may not be performed properly depending on the processing performance of the karaoke device.

The karaoke device according to an embodiment of the disclosure may receive sound source separation metadata including information on sound source separation, and perform sound source separation for the input audio signal by using the sound source separation metadata. The sound source separation metadata may include information on frequency band-specific masks used for sound source separation. In addition, the sound source separation metadata may include information on a time interval in which sound source separation is required, for example, a timestamp used for synchronization of lyrics and sound source. The time interval in which sound source separation is required may be a time interval in which voice that is a target of sound source separation is present. The input audio signal processing device may obtain information on a frequency band-specific mask to be used for sound source separation from sound source separation metadata and perform sound source separation by applying the mask for each frequency band according to the obtained information. In addition, the input audio signal processing device may perform sound source separation in a time interval in which sound source separation metadata indicates that sound source separation is required. This allows the karaoke device to reduce unnecessary processing and increase processing efficiency. In these embodiments, sound source separation metadata may be generated using a machine learning model. In this case, the machine learning model may output a frequency band-specific mask to be used for sound source separation from the input audio signal. In addition, the machine learning model may output a time interval in which sound source separation is required in the input audio signal.

The karaoke device according to an embodiment of the disclosure may receive lyrics metadata indicating information for synchronization of input lyrics and an input audio signal, and use sound source separation metadata to synchronize an output audio signal and output lyrics. Specifically, the lyrics metadata may include information indicating the time stamp of the input audio signal at which each syllable in the lyrics should be output. In addition, the lyric metadata may be generated using a machine learning model. In this case, the machine learning model may output the time stamp of the input audio signal corresponding to the syllable of the input lyrics.

In addition, the karaoke device may download the above-described sound source separation metadata and lyric metadata from a server.

Through this embodiment, the copyright issue that may occur may be prevented by streaming or storing an audio signal from which only the instrumental performance has been extracted in advance. In addition, through this embodiment, a singing practice service may be provided relatively freely from network communication performance constraints.

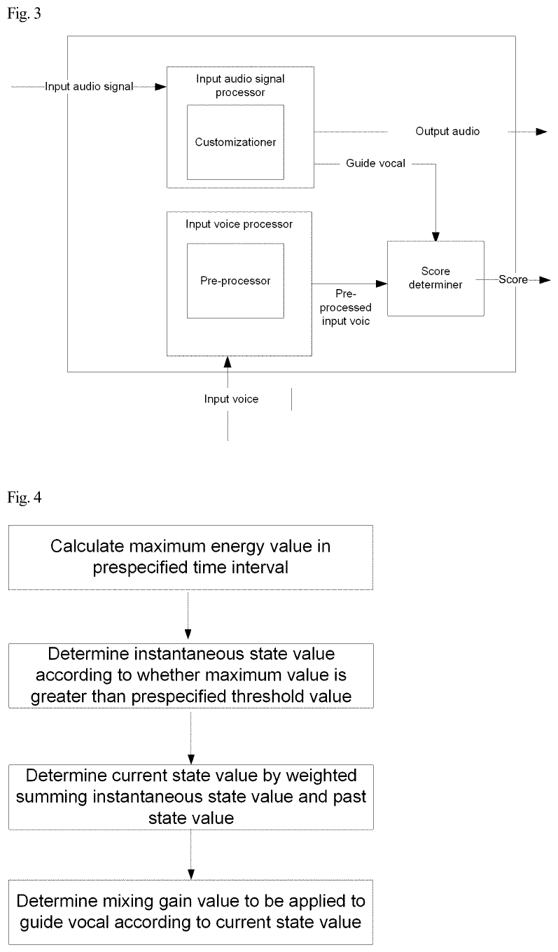

FIG. 3 illustrates an operation of a karaoke device processing an input audio signal and input voice according to an embodiment of the disclosure.

As described above, the karaoke device may customize the original sound source and output customized accompaniment. This is to help the convenience of a user's singing. For example, the user may adjust the pitch of the original sound source to match the user's vocal range. When the karaoke device adjusts the pitch of the original sound source, the karaoke device may not adjust the pitch of the audio corresponding to the percussion. Specifically, when the karaoke device adjusts the pitch of the original sound source, the karaoke device may bypass the audio signal corresponding to the percussion. In addition, when the karaoke device adjusts the pitch of the original sound source, the karaoke device may adjust only the pitch of the audio signal corresponding to the non-percussion instrument and the audio signal corresponding to the voice. This is because the sound of percussion instruments is not sensitive to pitch, and if the pitch is changed, the timbre of the percussion instrument's sound may be distorted. In these embodiments, the karaoke device may adjust the beat of the audio signal corresponding to the percussion instrument.

The karaoke device may output a user's singing score. The score determiner of FIG. 3 illustrates an operation of determining and outputting the user's singing score. The karaoke device may determine the user's singing score based on the input voice and the voice extracted from the original sound source. In this case, the karaoke device may perform preprocessing on the input voice and determine the user's singing score based on the preprocessed input voice. Specifically, the preprocessing may be a process of removing noise. In a specific embodiment, the preprocessing may be a process of separating a sound source or removing noise by using a machine learning model.

The karaoke device may determine the user's singing score by comparing the guide vocal, which is a voice extracted from the original sound source, and the preprocessed input voice. In this case, the guide vocal may be a vocal to which the customization described above has been applied to the voice included in the input audio signal. In addition, the karaoke device may determine the user's singing score based on the similarity between the guide vocal and the preprocessed input voice. In this case, the similarity may include the similarity of at least one of beat, pitch dynamics, pronunciation, volume, or vocal technique. The volume may include at least one of absolute volume or relative volume based on non-voice sounds in the original sound source. The vocal techinque may include at least one of a portamento or a vibrato. For example, the karaoke device may determine the user's singing score based on how high the similarity is between the guide vocal and the preprocessed input voice in terms of beat, pitch dynamics, pronunciation, volume, or vocal techinque. The karaoke device may determine the similarity between the PCM audio signal corresponding to the guide vocal and the PCM audio signal corresponding to the preprocessed input voice. In another specific embodiment, the karaoke device may convert the guide vocal into MIDI information, for example, at least one of pitch at each time stamp, sound size (velocity), or sound duration, and determine the similarity between the MIDI information and the preprocessed input voice.

In addition, the karaoke device may determine the user's singing score by using different weights of the similarity of each element that serves as a reference for the similarity described above. For example, similarity of pitch may contribute more to the evaluation than similarity of volume. In this case, the weight of the similarity for each element may be determined according to the evaluation mode. For example, the karaoke device may include an original singer mode, a professional mode, and an amateur mode, and the weights of the similarities of the respective elements may be determined depending on each mode. In addition, the granularity of the evaluation score may vary depending on the evaluation mode. For example, the evaluation score in the pro mode may be output up to the first decimal place, while the evaluation score in the amateur mode may be output in integer units.

The karaoke device may output the score for each element that is a reference for similarity, the score for each section, and the penalty factors. In addition, the karaoke device may output the evaluation score even before the singing is completed. For example, the karaoke device may output the intermediate score for 3 seconds at 30-second intervals.

As described above, when the user stops singing, the karaoke device may play back the original sound source voice as it is. The operation of the karaoke device for this purpose is described with reference to FIG. 4.

FIG. 4 illustrates a karaoke device determining an output of a guide vocal based on whether the user is singing according to an embodiment of the disclosure.

As described above, the karaoke device may calculate the mixing gain of the guide vocal depending on whether the user is singing. In this case, the mixing gain may be 0 or more and 1 or less. In addition, the karaoke device may determine whether to sing in units of two predetermined intervals. The predetermined time interval may be 1 frame rms. Specifically, the value of the instantaneous state may be determined depending on whether the maximum value of the energy within the predetermined time interval is greater than the predetermined threshold value. In this case, when the maximum value of the energy within the predetermined time interval is greater than the predetermined threshold value, the karaoke device may configure the instantaneous state value to 1. When the maximum value of the energy within the predetermined time interval is equal to or less than the predetermined threshold value, the karaoke device may configure the instantaneous state value to 0.

In addition, the karaoke device may determine the sensitivity for determining the singing state based on the tempo of the sound source or the number of syllables uttered per a predetermined unit time. The karaoke device may obtain the value of the current state by weighted summing the value of the instantaneous state and the value of the past state. In this case, the value of the past state may be the value of the state accumulated over the accumulated time interval. Specifically, when the karaoke device determines the transition from the non-singing state to the singing state, the karaoke device may obtain the current state value by using the following equation.

largeFrameState=stateAttackAlpha*instantState+(1−stateAttackAlpha)*pastInstantState

largeFrameState indicates the value of the current state. In addition, instantState indicates the value of the instantaneous state, for example, the current frame state value. In addition, stateAttackAlpha is a weight that determines the speed of transitioning from a non-singing state to a singing state. In addition, pastInstantState is a value in a past state, and indicates a value obtained by cumulatively obtaining the current state value in the previous frame. The current state value of the current frame is used as the past state value of the next frame.

In addition, when the karaoke device determines the transition from the singing state to the non-singing state, the karaoke may obtain the current state value by using the following equation.

largeFrameState=stateReleaseAlpha*instantState+(1−stateReleaseAlpha)*pastInstantState

largeFrameState indicates the value of the current state. In addition, instantState indicates the value of the instantaneous state, for example, the current frame state value. In addition, stateReleaseAlpha is a weight that determines the speed of transitioning from a singing state to a non-singing state. In addition, pastInstantState is a value in a past state, and indicates a value obtained by cumulatively obtaining the current state value in the previous frame. The current state value of the current frame is used as the past state value of the next frame.

In addition, the karaoke device may specify different speeds for applying the determination on the start of singing and the determination on the stop of singing. Specifically, the karaoke device may apply the determination on the start of singing faster than the determination on the stop of singing. In a specific embodiment, the karaoke device may use a value greater than the value of stateReleaseAlpha for stateAttackAlpha. This is to prevent the system from mistakenly identifying the breathing duration of the singer during singing as a pause in singing and to allow the starting part of the singing to be applied quickly.

The duration of the accumulated time interval may be determined according to the tempo of the original sound source or the number of syllables uttered per a predetermined unit time. Specifically, when the tempo of a first sound source is faster than the tempo of a second sound source, the duration of the accumulated time interval applied to the first sound source may be shorter than the duration of the accumulated time interval applied to the second sound source. In addition, when the number of syllables uttered per a predetermined unit time of the first sound source is greater than the number of syllables uttered per a predetermined unit time of the second sound source, the duration of the accumulated time interval applied to the first sound source may be shorter than the duration of the accumulated time interval applied to the second sound source. In addition, when the tempo of the first sound source is faster than the tempo of the second sound source, in the embodiments described above, the weight applied to the first sound source, for example, stateAttackAlpha or stateReleaseAlpha, may be greater than the weight applied to the second sound source, for example, stateAttackAlpha or stateReleaseAlpha. In addition, when the number of syllables uttered per a predetermined unit time of the first sound source is greater than the number of syllables uttered per a predetermined unit time of the second sound source, the weight applied to the first sound source, for example, stateAttackAlpha or stateReleaseAlpha, may be greater than the weight applied to the second sound source, for example, stateAttackAlpha or stateReleaseAlpha.

This allows the karaoke device to quickly apply the determination of whether to sing to fast-tempo sound sources.

The karaoke device may determine the value of the mixing gain based on the value of the current state. In this case, the karaoke device may determine the temporary mixing gain value based on the current state value, and determine the final mixing gain value by weighted summing the temporary mixing gain value and the previous mixing gain value. The value of the previous mixing gain may be the value of the final mixing gain directly obtained by the karaoke device. In addition, when the current state indicates a singing state, the value of the temporary mixing gain may be 0. In addition, when the current state does not indicate a singing state, the value of the temporary mixing gain may be 1.

In addition, the karaoke device may sequentially change the value of the mixing gain from the value of the previous state to the value of the current state. The karaoke device may adjust the speed of change of the final mixing gain according to the singing condition, depending on the tempo of the sound source or the number of syllables uttered per a predetermined unit time. Specifically, when the tempo of the first sound source is faster than the tempo of the second sound source, the speed at which the karaoke device changes the value of the final mixing gain in the first sound source may be faster than the speed at which the karaoke device changes the value of the final mixing gain in the second sound source. In addition, when the number of syllables uttered per a predetermined unit time of the first sound source is greater than the number of syllables uttered per a predetermined unit time of the second sound source, the speed at which the karaoke device changes the value of the final mixing gain in the first sound source may be faster than the speed at which the karaoke device changes the value of the final mixing gain in the second sound source.

Specifically, when the karaoke device detects that the singer starts singing, the karaoke device may apply the mixing gain value by using the following equation.

mixingGain=gainAttackAlpha*tempMixGain+(1−gainAttackAlpha)*prevMixGain

mixingGain indicates the value of the mixing gain that the karaoke device currently applies. tempMixGain indicates the value of a temporary mixing gain at the current time stamp, for example, the value of the temporary mixing gain corresponding to the current frame. prevMixGain indicates the value of the gain of mixing applied at the previous time stamp, for example, the previous frame. gainAttackAlpha is a parameter that determines the speed at which the mixing gain value changes when the karaoke device transitions from a non-singing state to a singing state.

mixingGain indicates the value of the mixing gain applied by the karaoke device.

Specifically, when the karaoke device detects that the singer stops singing, the karaoke device may apply the mixing gain value by using the following equation.

mixingGain=gainReleaseAlpha*tempMixGain+(1−gainReleaseAlpha)*prevMixGain

mixingGain indicates the value of the mixing gain that the karaoke device currently applies. tempMixGain indicates the value of a temporary mixing gain at the current time stamp, for example, the value of the temporary mixing gain corresponding to the current frame. prevMixGain indicates the value of the gain of mixing applied at the previous time stamp, for example, the previous frame. gainReleaseAlpha is a parameter that determines the speed at which the mixing gain value changes when the karaoke device transitions from a singing state to a non-singing state.

The value of gainAttackAlpha may be greater than the value of gainReleaseAlpha. In addition, the karaoke device may output the guide vocal as a MIDI signal in the embodiments described above. Specifically, the karaoke device may output the guide vocal as a MIDI signal according to the user's selection.

Some embodiments may also be implemented in the form of a recording medium including computer-executable instructions, such as a program module executed by a computer. A computer-readable medium may be any available medium accessible by a computer and may include both volatile and non-volatile media, and both removable and non-removable media. In addition, the computer-readable medium may include a computer storage medium. The computer storage medium may include both volatile and non-volatile, removable and non-removable media implemented by any method or technique for storing information, such as computer-readable instructions, data structures, program modules, or other data.

The above description has been made with reference to specific embodiments of the disclosure, but those of ordinary skill in the art to which the disclosure belongs may make various modifications and changes without departing from the scope and spirit of the disclosure. Although the disclosure describes an embodiment of the karaoke device and the operation method using the original sound source, the disclosure is equally applicable and extendable to various multimedia signals, including video signals as well as audio signals. Therefore, anything that may be easily inferred by a person skilled in the art to which the disclosure pertains from the detailed description and embodiments of the disclosure is interpreted as falling within the scope of the rights of the disclosure.

What is claimed is:

1. A karaoke device using an original sound source including a singing voice, the karaoke device comprising a processor,
wherein the processor is configured to:
obtain, from an audio signal corresponding to the original sound source, a first audio signal corresponding to the singing voice and a second audio signal corresponding to audio excluding the singing voice; and
determine a value of gain to mix the first audio signal with the second audio signal according to whether a user of the karaoke device sings.

2. The karaoke device of claim 1, wherein the processor is configured to, when applying the value of gain, change a value of mixing gain previously obtained according to whether the user sings to the determined value of mixing gain.

3. The karaoke device of claim 2, wherein the processor is configured to determine a speed of the change, based on a tempo of the original sound source.

4. The karaoke device of claim 2, wherein the processor is configured to determine a speed of the change, based on a number of syllables uttered per predetermined unit time of the original sound source.

5. The karaoke device of claim 2, wherein the processor is configured to configure a speed of the change when the user starts singing to be different from a speed of the change when the user stops singing.

6. The karaoke device of claim 1, wherein the processor is configured to, when adjusting a pitch of the audio corresponding to the second audio signal, adjust pitches of sounds except for a sound corresponding to percussion instruments.

7. The karaoke device of claim 1, wherein the processor is configured to:
receive sound source separation metadata indicating information required to separate the first audio signal from the audio signal corresponding to the original sound source; and
use the sound source separation metadata to obtain the second audio signal from the audio signal corresponding to the original sound source.

8. The karaoke device of claim 7, wherein the sound source separation metadata includes frequency band-specific mask information used for separation of the first audio signal.

9. The karaoke device of claim 7, wherein the sound source separation metadata includes information indicating a time interval in which separation of the first audio signal is required.

10. An operation method of a karaoke device using an original sound source including a singing voice, the operation method comprising:
obtaining, from an audio signal corresponding to the original sound source, a first audio signal corresponding to the singing voice and a second audio signal corresponding to audio excluding the singing voice; and
determining a value of gain to mix the first audio signal with the second audio signal according to whether a user of the karaoke device sings.

11. The operation method of claim 10, further comprising, when applying the value of gain, changing a value of mixing gain previously obtained according to whether the user sings to the determined value of mixing gain.

12. The operation method of claim 11, wherein the changing of the value of mixing gain previously obtained according to whether the user sings to the determined value of mixing gain comprises determining a speed of the change, based on a tempo of the original sound source.

13. The operation method of claim 11, wherein the changing of the value of mixing gain previously obtained according to whether the user sings to the determined value of mixing gain comprises determining a speed of the change, based on a number of syllables uttered per predetermined unit time of the original sound source.

14. The operation method of claim 11, wherein the changing of the value of mixing gain previously obtained according to whether the user sings to the determined value of mixing gain comprises configuring a speed of the change when the user starts singing to be different from a speed of the change when the user stops singing.

15. The operation method of claim 10, further comprising, when adjusting a pitch of the audio corresponding to the second audio signal, adjusting pitches of sounds except for a sound corresponding to percussion instruments.

16. The operation method of claim 10, further comprising:
receiving sound source separation metadata indicating information required to separate the first audio signal from the audio signal corresponding to the original sound source; and
using the sound source separation metadata to obtain the second audio signal from the audio signal corresponding to the original sound source.

17. The operation method of claim 16, wherein the sound source separation metadata includes frequency band-specific mask information used for separation of the first audio signal.

18. The operation method of claim 16, wherein the sound source separation metadata includes information indicating a time interval in which separation of the first audio signal is required.
